(19) United States
(12) Patent Application Publication
(10) Pub. No.: US 2013/0109799 A1
(43) Pub. Date: May 2, 2013

(54) Rubber Blend

(71) Applicant: Continental Reifen Deutschland GmbH, Hannover (DE)

(72) Inventor: Christian Weber, Garbsen (DE)

(73) Assignee: CONTINENTAL REIFEN DEUTSCHLAND GMBH, Hannover (DE)

(21) Appl. No.: 13/717,114

(22) Filed: Dec. 17, 2012

Related U.S. Application Data
(63) Continuation of application No. PCT/EP2011/060619, filed on Jun. 24, 2011.

(30) Foreign Application Priority Data
Jul. 7, 2010 (EP) 10168646.7

(51) Int. Cl. C08L 9/00

(52) U.S. Cl. CPC C08L 9/00
USPC 524/508

(57) ABSTRACT

A rubber blend, in particular for vehicle tires and various types of belts and hoses. The rubber blend has the following composition: 95 to 100 phr of at least, one natural or synthetic polyisoprene; 41 to 50 phr of at least one carbon black; 3 to 15 phr of at least, one process oil; 3 to 15 phr of at least one silicic acid; 1 to 7 phr of at least one adhesive resin; and, other additives.

### CROSS REFERENCE TO RELATED APPLICATIONS

This application is a continuation application of international patent application PCT/EP2011/060619, filed Jun. 24, 2011, designating the United States and claiming priority from European application 10168646.7, filed Jul. 7, 2010, and the entire content of both applications is incorporated herein by reference.

### FIELD OF THE INVENTION

The invention relates to a rubber mixture, particularly for pneumatic tires, and for belts, drive-belts, and hoses.

### BACKGROUND OF THE INVENTION

It is the rubber constitution of the tread that to a large extent determines the traveling properties of a tire, especially of a pneumatic tire. Similarly, the rubber mixtures which are used in drive-belts, hoses, and other belts, particularly at those places subject to high mechanical loading, are substantially responsible for stability and longevity of these rubber products. Accordingly, the requirements imposed on these rubber mixtures for pneumatic tires and for belts, drive-belts, and hoses are very exacting.

In order to improve the traveling properties, the tread—for example—of a pneumatic tire is often divided into two parts: firstly, into the upper tread part, which is in direct contact with the roadway and referred to as the cap, and secondly into the underlying lower tread part, which is also referred to as the base.

The base here has a number of functions to fulfill. The use of a base is supposed to reduce the rolling resistance of the tire, and so the mixture used must possess a low hysteresis. At the same time, the rubber mixture of the base roust exhibit sufficiently high tack during the tire manufacturing operation, so that the tread remains adhering to the tire carcass. For a variety of reasons, many rubber mixtures for the cap use a relatively high amount of silica, which means in turn that the electrical conductivity of the upper tread part is only very low, or is zero. In that case it is necessary to ensure the electrical conductivity of the tread through the use of a “carbon center beam”, that is, of a conductive path which pervades the cap and is composed of an electrically conductive rubber mixture containing carbon black—this can entail additional production cost and complexity, if the base mixture does not possess sufficient electrical conductivity. In this case it is necessary to use a further, additional rubber mixture. As well as all of these requirements, the structural durability must be ensured as well. For environmental reasons, there is presently a focus on the low rolling resistance of a pneumatic tire, meaning that those properties referred to as the handling properties play only a minor role, unless they jeopardize the driving safety. For this reason, currently, rubber mixtures are used for the base that posses a low stiffness. It is known that the requirements identified above, such as low hysteresis, sufficient tack, electrical conductivity, and structural durability, are in conflict with one another and that usually only an unsatisfactory compromise can be found—that is, any improvement in respect of one requirement is accompanied by a deterioration in at least one further requirement. For example, the “low hysteresis” requirement demands a rubber mixture with a low degree of filling and a high degree of crosslinking, but this leads to a poor electrical conductivity and a low structural durability.

There is also a conflict of objectives between the crack resistance (structural durability), and the hysteresis (rolling resistance). At the same time the electrical conductivity must be sufficiently high, so that the overall tire complies with defined limit values.

Such requirements are also found with industrial rubber products, such as belts and drive-belts.

EP 1 589 068 A1 discloses rubber mixtures for the tread base that comprise a combination of 5 to 50 phr of butadiene rubber and 50 to 95 phr of polyisoprene as a rubber component. The rubber mixture comprises an activated carbon black as its sole filler component, preferably in amounts of 55 to 75 phr. The rubber mixture has high flexibility in conjunction with high stiffness, in order thus to improve the handling qualities.

For the purpose of improving the chipping and chunking characteristics of a pneumatic tire tread, the rubber mixture described in U.S. Pat. No. 7,902,285 comprises 5 to 80 phr of a mineral oil plasticizer and 5 to 30 phr of a resin having a defined molecular weight and softening point, plus 5 to 100 phr of a defined carbon black. A rubber component which is used in high amounts here is styrene-butadiene rubber.

U.S. patent application publication 2011/0071245 describes a rubber mixture, particularly for the base of a tread, which is distinguished by improved heat buildup and improved abrasion characteristics. The rubber mixtures described therein contain only 20 to 40 phr of a carbon black.

### SUMMARY OF THE INVENTION

The object on which the invention is based, therefore, is to provide a rubber mixture, more particularly for pneumatic tires with a cap/base tread construction, that is able to resolve the conflict between low hysteresis, sufficient tack, electrical conductivity, and structural durability, and hence to allow the use of rubber mixtures with low hysteresis, particularly for the base of a pneumatic tire, without adversely affecting the tire production operation or the other properties of the tire.

This object is achieved by means of a rubber mixture having the following constitution;
95 to 100 phr of at least one natural or synthetic polyisoprene and
41 to 50 phr of at least one carbon black and
3 to 15 phr of at least one plasticizer oil and
3 to 15 phr of at least one silica and
1 to 7 phr of at least one tackifier resin, and
further additives.

The unit phr (parts per hundred parts of rubber by weight) used in this specification is the usual quantity unit in the rubber industry for mixture formulas. The metering of the parts by weight of the individual substances here is always based on 100 parts by weight of the total mass of ail the rubbers present in the mixture.

Surprisingly it has been found that through the combination of a comparatively high weight fraction of natural and/or synthetic polyisoprene and 41 to 50 phr of a carbon black, and a relatively small amount of silica, rubber mixtures are made possible that have a relatively low hysteresis, especially for the base of a pneumatic tire, without any adverse effect on the Lire production operation or the other tire properties. Moreover, surprisingly, the tack is good arid the electrical conductivity is good. This is true not only in respect of the vehicle tread, and especially the base, but also in respect of further, internal tire components. The rubber mixtures for the further internal tire components are summarized below and, as is usual in tire technology, are also referred to as body compounds or body mixtures.

The term “body mixture” essentially comprises sidewall, inner liner, apex, belt, shoulder, belt profile, squeegee, carcass, bead reinforcement, other reinforcement inserts, and/or solid tire.

The rubber mixture of the invention finds further application in the development of mixtures for drive-belts, other belts, and hoses, since there as well requirements are imposed with regard to low hysteresis, sufficient tack, electrical conductivity, and structural durability.

The rubber mixture comprises 95 to 100 phr, preferably 98 to 100 phr, of at least one natural or synthetic polyisoprene and 0 to 5 phr, preferably 0 to 2 phr, of a further polar or apolar rubber.

The polar or apolar rubber is selected in this case from the group consisting of butadiene rubber and/or styrene-butadiene rubber and/or solution-polymerized styrene-butadiene rubber and/or emulsion-polymerized styrene-butadiene rubber and/or liquid rubbers and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluoro rubber and/or silicone rubber and/or polysulfide rubber and/or epichlorohydrin rubber and/or styrene-isoprene-butadiene terpolymer. More particularly, styrene-isoprene-butadiene terpolymer, butyl rubber, halobutyl rubber or ethylene-propylene-diene rubber are employed in producing industrial rubber products.

Preference is given to using at least one butadiene rubber as the further polar or apolar rubber.

The rubber mixture of the invention comprises 3 to 15 phr, preferably 3 to 10 phr, more preferably 3 to 6 phr, of silica. The total amount of silica here is attached to the polymer matrix, in a particularly advantageous embodiment, by a coupling agent, preferably silane.

The silicas used in the tire industry are generally precipitated silicas, which are characterized in particular according to their surface area. Characterization here takes place by specification of the nitrogen surface area (BET) in accordance with DIN 66131 and DIN 66132, as a measure of the internal and external surface area of the filler, in m²/g, and of the CTAB surface area to ASTM D 3765, as a measure of the external surface area, which is often considered to be the rubber-active surface area, in m²/g.

Used in accordance with the invention are silicas having a nitrogen surface area of between 120 and 300 m²/g, preferably between 150 and 250 m²/g, and a CTAB surface area of between 120 and 230 m²/g, preferably between 140 and 200 m²/g.

The amount of the silane that is advantageously used is 0.1 to 5 phr, preferably 0.1 to 2 phr. Silane coupling agents which may be used here are all of the silane coupling agents known to the skilled person for use in rubber mixtures. It is also possible, however, for the silica not to be attached—in other words, for no coupling agent to be used.

The use of silica activated in this way provides advantages in terms of tensile properties in the working examples that are set out later on below.

Particularly for the use of the rubber mixture of the invention as a base of the tread of a tire, sufficient tack on the part of the unvulcanized mixture is an absolute necessity, so that the tread remains adhering during the production operation. For this purpose the rubber mixture must contain at least 1 to 5 phr of a tackifier resin. Tackifier resins used are natural or synthetic resins, such as hydrocarbon resins, which act as tackifiers. The hydrocarbon resins may be phenolic, aromatic or aliphatic. The tackifier resins are preferably selected from the group consisting of rosins and their esters, terpene-phenolic resins, alkyne-phenolic resins, phenolic resins, and coumarone-indene resins, with phenolic resins being especially suitable for the present invention.

The rubber mixture of the invention further comprises 3 to 15 phr, preferably 3 to 10 phr, of at least one plasticizer oil, the plasticizer oil preferably being a mineral oil selected from the group consisting of DAE (distilled aromatic extracts) and/or EAS (residual aromatic extract) and/or TDAE (treated destilled aromatic extracts) and/or MES (mild extracted solvents) and/or naphthenic oils. It is advantageous to add a plasticizer oil to the rubber mixture for the base of a tread, since in the finished tire, plasticizers migrate generally in accordance with the concentration gradient, and the migration can foe limited by means of the stated measure. A positive influence on the rolling resistance characteristics has been observed when the plasticizer oil has a relatively low glass transition temperature (T_{g}). It is therefore extremely preferred to use MES, very preferred to use TDAE, and preferred to use RAE.

Within the rubber mixture there may also be 0 to 5 phr of at least one further, additional plasticizer. This further plasticizer may be a synthetic plasticizer and/or a fatty acid and/or a fatty acid derivative and/or a resin and/or a factice and/or a vegetable oil or a BTL (biomass-to-liquid) oil.

Furthermore, in a preferred embodiment the rubber mixture comprises 41 to 50 phr of at least one carbon black. It is preferred here if the carbon black possesses an iodine number to ASTM D 1510 of between 60 and 300 g/kg, preferably between 80 and 130 g/kg, and a DBF number to ASTM D 2414 of between 80 and 200 cm³/100 g, preferably between 100 and 140 cm³/100 g. The iodine number to ASTM D 1510 is also referred to as the iodine absorption number. The DBP number to ASTM D 2414 defines the specific absorption volume of a carbon black or of a light-colored filler by means of dibutyl phthalate. The use of a carbon black with these qualities has advantages in terms of the abrasion behavior of the overall tread, since small amounts of the base carbon black get into the cap rubber mixture as a result of the return process during the tire production operation. Tire tests have shown that even such small amounts (ca. 1 to 3 phr) in the cap mean that there is a distinct deterioration in abrasion when carbon blacks are used whose iodine and DBF numbers deviate from those specified above.

The rubber mixture further comprises, preferably, 0.1 to 10 phr, more preferably 0.2 to 8 phr, very preferably 0.2 to 4 phr, of zinc oxide. It is usual to add zinc oxide as an activator, usually in combination with fatty acids (for example, stearic acid), to a rubber mixture for sulfur crosslinking with vulcanization accelerators. The sulfur is then activated for vulcanization by formation of a complex. The zinc oxide conventionally used in this case has a BET surface area generally of less than 10 m²/g. However, so-called nano-zinc oxide, with a BET surface area of 10 to 60 m²/g, can also be used.

The rubber mixture additionally comprises further additives. Further additives include, substantially, the crosslinking system (crosslinkers, accelerators, and retardants), ozone inhibitors, aging inhibitors, masticating assistants, and further activators. The proportion of the total amount of further additives is 2 to 50 phr, preferably 4 to 20 phr.

The rubber mixture is vulcanized in the presence of sulfur or sulfur donors; certain sulfur donors may also act as vulcanization accelerators. Sulfur or sulfur donors is or are added to the rubber mixture in the last mixing step, in the amounts customary to the skilled person (0.4 to 4 phr; sulfur preferably in amounts of 1.5 to 2.5 phr). To control the required time and/or temperature of the vulcanization and in order to improve the properties of the vulcanizate, the rubber mixture may comprise vulcanization modifiers such as vulcanization accelerators, vulcanization retardants, which in accordance with the invention are present in the above-described additives, and vulcanization activators, as described above.

The rubber mixture of the invention is produced by the method customary in the rubber industry, which involves first, in one or more mixing stages, preparing a basic mixture including all of the ingredients apart from the vulcanizing system (sulfur and vulcanization modifiers). Addition of the vulcanizing system in a final mixing stage produces the completed mixture. The completed mixture is processed further by an extrusion operation, for example, and brought into the appropriate form.

A further object on which the invention is based is that of using the above-described rubber mixture for producing pneumatic tires, more particular for producing the base of the tread of a tire and/or a body mixture of a tire, and for producing drive-belts, other belts, and hoses.

For use in pneumatic tires, the mixture is preferably brought into the form of a tread and is applied in a known manner during the production of the green tire. Alternatively the tread, in the form of a narrow strip of rubber mixture, can be wound onto a green tire. If the tread is in two parts, as described at the outset, then the rubber mixture is employed preferably as the mixture for the base.

Production of the rubber mixture of the invention for use as a body mixture in vehicle tires takes place as already described for the tread. The difference lies in the shaping after the extrusion operation. The resultant forms of the rubber mixture of the invention for one or more different body mixtures are then used to construct a green tire. For the use of the rubber mixture of the invention in drive-belts and other belts, more particularly in conveyor belts, the extruded mixture is brought into the appropriate form, and, during this procedure or afterward, is frequently provided with strength elements, examples being synthetic fibers or steel cords. This usually produces a multilayer construction, consisting of one and/or a plurality of layers of rubber mixture, one and/or a plurality of layers of the same and/or different strength elements, and one and/or a plurality of further layers of the same and/or of another rubber mixture. A sufficient tack is also relevant here, for example, so that a firmly adhering assembly can be formed between the individual layers or between the rubber mixture and the strength elements.

### DESCRIPTION OF THE PREFERRED EMBODIMENTS OF THE INVENTION

The invention will now be elucidated in more detail by means of comparative examples and working examples, which are summarized in Table 1. Inventive mixtures begin with “I”, while the comparative mixtures are labeled with “C”.

For all of the mixing examples present in the table, the quantity figures indicated are parts by weight, and are based on 100 parts by weight of total rubber (phr).

Mixtures were produced under usual conditions in. two stages in a laboratory tangential mixer. Test specimens were produced from all of the mixtures by vulcanization, and these test specimens were used for determining physical properties typical for the rubber industry. The test methods employed for the above-described tests on test specimens were as follows:
Shore A hardness at room temperature (RT) in accordance with DIN 53 505
Rebound resilience at room temperature (RT) and 70° C. in accordance with DIN 53 512
Stress values (modulus) at 100% and 200% elongation at room temperature (RT) in accordance with DIM 53 504
Tensile strength at room temperature (RT) in accordance with DIN 53 504
Graves tear resistance at room temperature (RT) in accordance with DIN 53 515
Energy at break at room temperature (RT) in accordance with DIN 53 448
Elongation at break at room temperature (RT) in accordance with DIN 53 504
Dynamic storage modulus E′ at 55° C. in accordance with DIN 53 513 at 8% elongation
Volume resistance in accordance with standard DIN IEC 93
^{a} SMR 10
^{b} High-cis polybutadiene, cis fraction ≧95% by weight
^{c} VN3 from Evonik
^{d} TESPD
^{e} MES
^{f} Phenolic resin, Koresinφ from BASF
^{g} Aging inhibitors, ozone inhibitor wax, stearic acid, CTP
^{h} sulfenamide accelerator, CBS

TABLE 1

| | Unit | C1 | C2 | C3 | C4 | C5 | I1 | I2 | I3 |
|---|---|---|---|---|---|---|---|---|---|
| Constituents | | | | | | | | | |
| Polyisoprene^{a} | phr | 100 | 100 | 80 | 100 | 100 | 100 | 100 | 100 |
| BR^{b} | phr | — | — | 20 | — | — | — | — | — |
| Silica^{c} | phr | 4 | — | — | — | — | 4 | 4 | 4.5 |
| Silane^{d} | phr | 0.5 | — | — | — | — | 0.5 | — | 0.5 |
| Carbon black, N339 | phr | 38 | 41 | 41 | 41 | 59 | 41 | 41 | 44 |
| Plasticizer oil^{e} | phr | 1 | 1 | 1 | 6 | 9 | 5 | 5 | 8 |
| Tackifier resin^{f} | phr | 2 | 2 | 2 | 2 | 2 | 2 | 2 | 2 |
| ZnO | phr | 3 | 3 | 3 | 3 | 3 | 3 | 3 | 3 |
| Further additives^{g} | phr | 7.8 | 7.8 | 7.8 | 7.8 | 7.8 | 7.8 | 7.8 | 7.8 |
| Acclerator^{h} | phr | 2.4 | 2.4 | 2.4 | 2.4 | 3 | 2.4 | 2.4 | 2.6 |
| Sulfur | phr | 2.1 | 2.1 | 2.1 | 2.1 | 2.5 | 2.1 | 2.1 | 2.2 |
| Property | | | | | | | | | |
| Hardness RT | ShA | 59 | 60 | 61 | 59 | 65 | 60 | 59 | 61 |
| Rebound RT | % | 59 | 58 | 16 | 59 | 46 | 58 | 55 | 58 |
| Rebound 70° C. | % | 72 | 71 | 72 | 74 | 61 | 73 | 68 | 73 |
| Modulus 100% | MPa | 2.1 | 2.4 | 2.3 | 2.3 | 3.6 | 2.4 | 2.3 | 2.5 |
| Modulus 200% | MPa | 6.4 | 7 | 6.8 | 7 | 11.2 | 7.4 | 6.7 | 7.5 |
| E′ 55° C., 8% | MPa | 4.5 | 4.7 | 5 | 4.3 | 6.3 | 4.6 | 4.5 | 4.7 |
| Tensile Strength | MPa | 24 | 24 | 21 | 23 | 21 | 21 | 21 | 21 |
| Elongation at break | % | 490 | 470 | 430 | 460 | 350 | 430 | 430 | 410 |
| Energy at break | MJ/m³ | 3.2 | 3.1 | 3.1 | 2.6 | 2.9 | 3.1 | 3.1 | 3 |
| Tear resistance | N/mm | 62 | 49 | 37 | 48 | 56 | 51 | 52 | 50 |
| Volume resistance | Ω * cm | 5E+08 | 2E+04 | 2E+04 | 3E+04 | 2E+03 | 3E+04 | 3E+04 | 1E+04 |

Investigations have shown that, for the rubber mixture for the base of a pneumatic tire tread, the rebound value at 70° C. is correlated with the roiling resistance characteristics, and the hardness at RT is correlated with the handling. Established parameters for the structural durability are the energy at break and the tear resistance, as physical mixture parameters for characterizing the crack resistance.

An objective of the present invention is to achieve the optimization of minimal hysteresis while retaining the crack resistance and the electrical conductivity, in conjunction with sufficient tack.

Thus it can be seen from Table 1, for example, that the hysteresis can be lowered by reducing the filler content (comparison of mixture C5 and the remaining mixtures). Between 41 phr carbon black and 38 phr carbon black there is, very surprisingly, a sudden drop in the electrical conductivity by around four powers of ten (mixture C1 and I1, I2). Above 50 phr carbon black, however, surprisingly, there is a very sharp drop in the rebound (mixture C5), which can no longer be countercompensated by more extensive crosslinking plus plasticizer oil, without the crack resistance becoming significantly poorer. Moreover, a better crack resistance is found through the addition of comparatively small amounts of activated silica. Looking at mixtures C1 to C4 and I1 to I3, which have a similar value for the rebound, it is seen that the mixtures C1 and I1 to I3 have higher values for the energy at break and for the tear resistance than do the corresponding mixtures without silica, C2 to C4. The omission of the activator in the form of the coupling agent results in a lower value for the rebound, without any improvement in the other properties (mixtures I1 and I2). It is evident, furthermore, that, it is advantageous to use polyisoprene in amounts of more than 95 phr. The crack resistance of such a mixture significantly exceeds that of a mixture which contains more than 5 phr of a further rubber (mixtures C2 and C3).

From Table 1 it can therefore be seen that only the inventive mixtures I1 to I3 are able to solve satisfactorily the problem posed in the present invention.

It is understood that the foregoing description, is that of the preferred embodiments of the invention and that various changes and modifications may be made thereto without departing from the spirit and scope of the invention as defined in the appended claims.

What is claimed is:

1. A rubber mixture comprising:
95 to 100 phr of at least one natural, or synthetic polyisoprene;
41 to 50 phr of at least one carbon black;
3 to 15 phr of at least one plasticizer oil;
3 to 15 phr of at least one silica;
1 to 7 phr of at least one tackifier resin; and,
optionally, further additives.

2. The rubber mixture of claim 1, comprising 98 to 100 phr of the at least one natural or synthetic polyisoprene.

3. The rubber mixture of claim 1, wherein the silica has been activated by a coupling agent.

4. The rubber mixture of claim 3, wherein the coupling agent is a silane.

5. The rubber mixture of claim 4, wherein the amount of the silane is 0.1 to 5 phr.

6. The rubber mixture of claim 1, wherein the amount of silica is 3 to 10 phr.

7. The rubber mixture of claim 1, comprising 3 to 10 phr of a plasticizer oil.

8. The rubber mixture of claim 1, wherein the plasticizer oil is a mineral oil.

9. The rubber mixture of claim 8, wherein the mineral oil is mild extracted solvents (MES).

10. The rubber mixture of claim 1, wherein the carbon black has an iodine absorption number to ASTM D 1510 of 60 to 300 g/kg and a DBP number to ASTM D 2414 of 80 to 200 cm³/100 g.

11. The rubber mixture of claim 1, wherein the tackifier resin is a phenolic resin.

12. A method of producing the rubber mixture of claim 1 comprising preparing a basic mixture.

13. The method of claim 12 for producing a pneumatic tire.

14. The method of claim 13 for producing a tread or a body mixture of a pneumatic tire.

15. The method of claim 12 for producing a belt, drive-belt, or hose.
